(19) United States
(12) Patent Application Publication
(10) Pub. No.: US 2009/0258616 A1
(43) Pub. Date: Oct. 15, 2009

(54) MULTISYSTEM WIRELESS COMMUNICATION APPARATUS

(75) Inventors: Takashi Miura, Kanagawa (JP); Ritsu Miura, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/995,435

(22) PCT Filed: Jun. 21, 2006
(86) PCT No.: PCT/JP2006/312444

§ 371 Date: Jan. 11, 2008

(51) Int. Cl. H04B 1/04

(52) U.S. Cl. 455/127.1

(57) ABSTRACT

A wireless communication apparatus capable of being communicated by employing communication systems is provided with: communication units containing a system-A communication unit for performing a communication operation by a wireless signal using a GSM communication system, and a system-B communication unit for performing a communication operation by an wireless signal using a UMTS communication system; a power supply voltage detecting unit for detecting a voltage of a power supply applied to the communication units in a predetermined time period; and a power supply control unit operated in such a control manner that when the power supply voltage is lower than, or equal to the final voltage of the GSM communication system, the communication operation by the system-A communication unit is stopped, whereas the power supply voltage is higher than the final voltage of the UMTS communication system, the communication operation by the system-B communication unit is continuously carried out.

### TECHNICAL FIELD

The present invention is related to a wireless communication apparatus and a wireless communication method, capable of performing a communicating operation by employing a plurality of communication systems.

### BACKGROUND ART

In mobile communication systems typically known as portable telephones, while various sorts of modulation systems have been provided in connection with growths of mobile communications, multisystem terminals capable of utilizing a plurality of modulation systems have been developed in order to increase the number of users and improve utility in the present stage. For instance, while being connectable with GSM (Global System for Mobile Communications) networks and UMTS (Universal Mobile Telecommunications system) networks, there are provided UMTS/GSM dual mode terminals which hand over the GSM networks and the UMTS networks. Various methods have been so far proposed in order to improve telephone call waiting time/telephone communication time of these multi-mode terminals.

For example, switching systems for properly switching communication systems have been proposed, while judging long, or short waiting times of plural communication systems based upon remaining battery capacities and communication speeds (refer to, for example, patent publication 1). Also, hand-over methods have been proposed in which referring to electric field strengths of signals transmitted from respective base stations, such a base station that power consumption required in the own signal transmission may become the minimum value is selected based upon the electric field strengths, and then, the communication operation made by the present base station is handed over to the selected base station (refer to, for instance, patent publication 2).

### Patent Publication 1: JP-A-2004-235863

### Patent Publication 2: JP-A-2004-289756

### DISCLOSURE OF THE INVENTION

### Problems that the Invention is to Solve

However, in the conventional techniques, these multisystem terminals never consider proper measures with respect to battery voltages required for the respective communication systems, and final voltages of the multisystem terminals are determined based upon a final voltage in such a system that a requirement for a battery voltage is a high degree. As a consequence, as shown in FIG. 2, in such a case that a final voltage is determined by a system “A” having a high requirement for a battery voltage, the following event occurs. That is, in another system “B” having a low requirement for a battery voltage, the operation of this system “B” is ended while the battery energy is not completely consumed. FIG. 2 is a discharge characteristic diagram as to a general-purpose battery.

For example, in the case that a dual mode terminal operable in the UMTS and GSM systems is considered, generally speaking, a voltage required for a power amplifier (PA) used in the GSM system is higher than a voltage required for a power amplifier (PA) used in the UMTS system. Therefore, a final voltage for the GSM system is set to be higher than that of the UMTS system. As a consequence, when a final voltage of the dual mode terminal is set based upon the GSM system, although the dual mode terminal can be still operated for the UMTS system, the present battery voltage becomes the final voltage, so that the operation of the dual mode terminal is ended while the battery energy cannot be completely consumed.

The present invention has been made to solve the above-explained problem, and therefore, has an objet to provide a wireless communication apparatus and a wireless communication method, operable in that when a plurality of systems are employed, battery energy can be completely consumed even in such a system, the battery voltage requirement of which is the lowest degree.

### Means for Solving the Problems

To achieve the above-explained object, a first wireless communication apparatus, according to the present invention, is featured by such a wireless communication apparatus capable of being communicated by employing a plurality of communication systems, comprising: a plurality of communication units including a first communication unit for performing a communication operation by a wireless signal using a first communication system and a second communication unit for performing a communication operation by a wireless signal using a second communication system; a storage unit for storing thereinto final voltages of the communication systems with respect to the plural communication systems; a power supply voltage detecting unit for detecting a voltage of a power supply applied to the plural communication units in a predetermined time period; a comparing unit for comparing the power supply voltage with the final voltage for every communication system; and a power supply control unit operated in such a control manner that as a result of the comparison made by the comparing unit, when the power supply voltage is lower than, or equal to the final voltage of the first communication system, the communication operation by the first communication unit is stopped, whereas when the power supply voltage is higher than the final voltage of the second communication system, the communication operation by the second communication unit is continuously carried out.

With employment of the above-described arrangement, the supply of the power supply voltage to the system whose battery voltage becomes lower than, or equal to the final voltage is cut off so as to stop the intermittent receiving operation. As a result, the telephone call waiting time may be increased, so that the battery energy can be completely consumed even in such a system, the requirement for the battery voltage of which is the lowest degree.

Also, a second wireless communication apparatus, according to the present invention, is featured by that in the case that the power supply voltage is lower than, or equal to the final voltage of the first communication system, and further, the power supply voltage is higher than the final voltage of the second communication system as a result of the comparison made by the comparing unit, the power supply control unit switches the communication operation from the first communication unit to the second communication unit.

With employment of the above-explained arrangement, the telephone communication is switched from the system whose battery voltage becomes lower than, or equal to the final voltage thereof to another system during the telephone communication. As a result, the telephone communication time can be increased, so that the battery energy can be completely consumed even in such a system, the requirement for the battery voltage of which is the lowest degree.

Also, a first wireless communication method, according to the present invention, is featured by such a wireless communication method capable of being communicated by employing a plurality of communication systems, comprising: a plurality of steps including a first communication step for performing a communication operation by a wireless signal using a first communication system and a second communication step for performing a communication operation by a wireless signal using a second communication system; a step for storing thereinto final voltages of the communication systems with respect to the plural communication systems; a step for detecting a voltage of a power supply applied to the plural communication units in a predetermined time period; a comparing step for comparing the power supply voltage with the final voltage for every communication system; and a power supply control step executed in such a control manner that as a result of the comparison made by the comparing step, when the power supply voltage is lower than, or equal to the final voltage of the first communication system, the communication operation by the first communication step is stopped, whereas when the power supply voltage is higher than the final voltage of the second communication system, the communication operation by the second communication step is continuously carried out.

With employment of the above-described method, the supply of the power supply voltage to the system whose battery voltage becomes lower than, or equal to the final voltage is cut off so as to stop the intermittent receiving operation. As a result, the telephone call waiting time may be increased, so that the battery energy can be completely consumed even in such a system, the requirement for the battery voltage of which is the lowest degree.

Also, a second wireless communication method, according to the present invention, is featured by that in the case that the power supply voltage is lower than, or equal to the final voltage of the first communication system, and further, the power supply voltage is higher than the final voltage of the second communication system as a result of the comparison made by the comparing step, the power supply control step switches the communication operation from the first communication step to the second communication step.

With employment of the above-explained method, the telephone communication is switched from the system whose battery voltage becomes lower than, or equal to the final voltage thereof to another system during the telephone communication. As a result, the telephone communication time can be increased, so that the battery energy can be completely consumed even in such a system, the requirement for the battery voltage of which is the lowest degree.

### ADVANTAGE OF THE INVENTION

In accordance with the present invention, it is possible to provide the wireless communication apparatus and the wireless communication method, operable in that when the plurality of systems are employed, the battery energy can be completely consumed even in such a system, the battery voltage requirement of which is the lowest degree.

Also, while the optimum final voltage can be set for every system and the battery energy can be completely consumed, the supply of the power supply voltage to the system whose voltage is reached to the final voltage thereof is cut off. As a result, the power consumption can be decreased and the telephone call waiting time can be increased.

When one system which is used in a telephone communication is reached to the final voltage thereof, if another system is not reached to the final voltage thereof and is communicable, then the present system can be handed over to the latter system.

### BRIEF DESCRIPTION OF THE DRAWINGS

FIG. 1 is a block diagram for indicating a wireless communication apparatus according to an embodiment mode of the present invention.

FIG. 2 represents an example as to a discharge characteristic of a general-purpose battery.

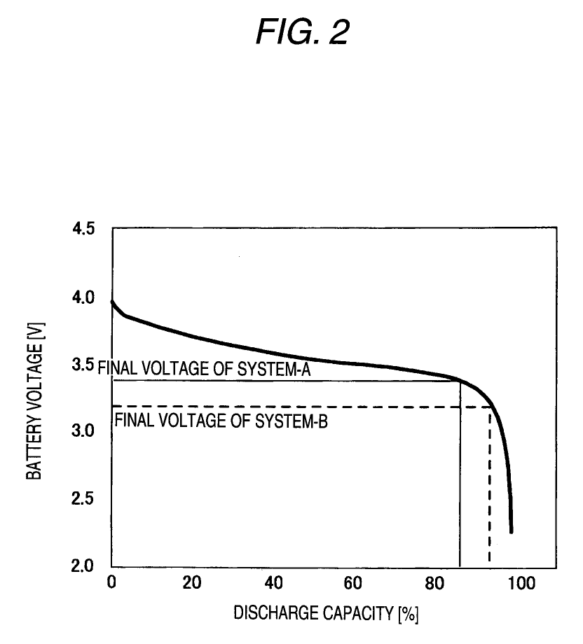

FIG. 3 is a flow chart for explaining process operations of the wireless communication apparatus during telephone communication, according to the embodiment mode of the present invention.

FIG. 4 is a flow chart for describing process operations of the wireless communication apparatus during telephone call waiting time, according to the embodiment mode of the present invention.

### DESCRIPTION OF REFERENCE NUMERALS AND SIGNS

100 wireless communication apparatus
11 antenna
12 system-A transmitting/receiving unit
13 system-A control unit
14 system-B transmitting/receiving unit
15 system-B control unit
16 power supply control unit
17 storage unit
19 battery voltage detecting unit
21 battery

### BEST MODE FOR CARRYING OUT THE INVENTION

Referring now to drawings, embodiment modes of the present invention will be described.

### Embodiment

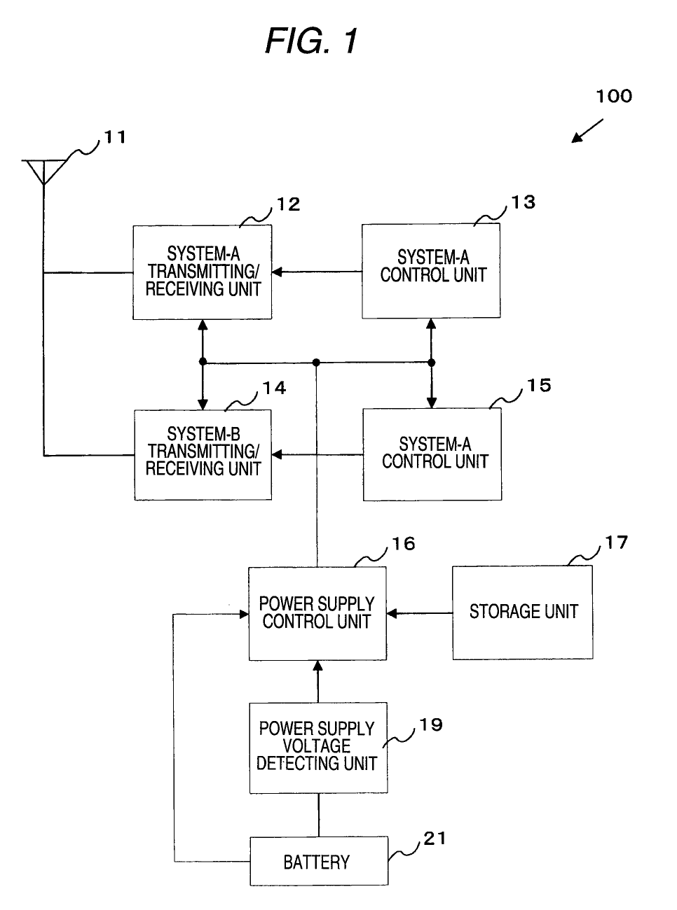

FIG. 1 is a block diagram for showing an example as to an arrangement of a wireless communication apparatus 100 according to an embodiment of the present invention. The wireless communication apparatus 100 is premised on, for example, a dual mode terminal having two systems. The wireless communication apparatus 100 contains an antenna 11, a system-A transmitting/receiving unit 12, a system-A control unit 13, a system-B transmitting/receiving unit 14, a system-B control unit 15, a power supply control unit 16, a storage unit 17, a battery voltage detecting unit 19, and a battery 21. It is so assumed in the embodiment that a plurality of systems are operated at different final voltages.

The transmitting/receiving units 12, 14, and the control units 13, 15 are examples of partial units of a plurality of communication units. A portion of the power supply control unit 16 corresponds to one example as to a comparing unit, and the power supply control unit.

The system-A transmitting/receiving unit 12 receives a wireless signal to a system A from a base station (not shown) and transmits a wireless signal to a base station from the system A via the antenna 11. The system-A control unit 13 demodulates a wireless signal received by the system-A transmitting/receiving unit 12, and modulates a transmission signal. The system-A control unit 13 notifies to the system-A transmitting/receiving unit 12, such an information as to whether or not communications are to be executed between a base station and the system-A transmitting/receiving unit 12 based on an instruction from the power supply control unit 16.

The system-B transmitting/receiving unit 14 performs a reception of a wireless signal to a system B from a base station (not shown) and a transmission of a wireless signal to a base station from the system B via the antenna 11. The system-B control unit 15 demodulates a wireless signal received by the system-B transmitting/receiving unit 14, and modulates a transmission signal. The system-B control unit 15 notifies to the system-B transmitting/receiving unit 14, such an information as to whether or not communications are to be executed between a base station and the system-B transmitting/receiving unit 14 based on an instruction from the power supply control unit 16.

The storage unit 17 stores thereinto final voltage information which contains information related to a final voltage set for each system. The battery voltage detecting unit 19 detects a battery voltage from the battery 21 in a predetermined time period, and sends battery voltage information containing information related to the battery voltage to the power supply control unit 16. The power supply control unit 16 applies voltages to the transmitting/receiving unit 12, 14 and the control unit 13, 15 based on the final voltage information and the battery voltage information, i.e., based on a result of comparing the levels of the final voltage and the battery voltage with each other.

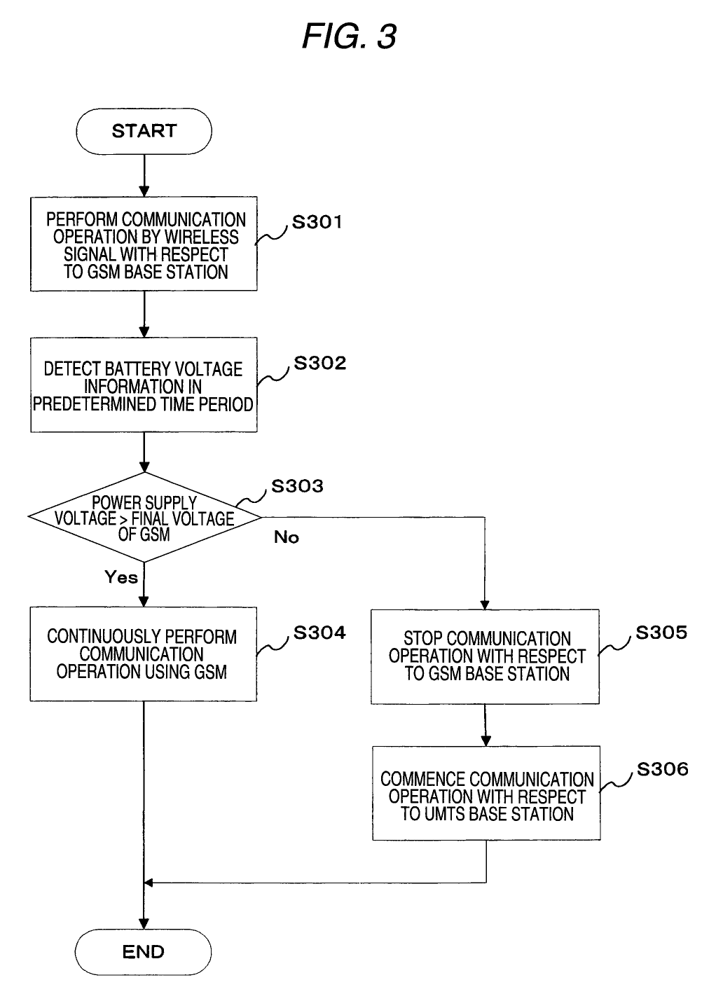

A description will now be made of operations when the wireless communication apparatus 100 according to the embodiment performs telephone communication. FIG. 3 is a flow chart for explaining process operations when the wireless communication apparatus 100 according to the embodiment of the invention operated in a telephone communication. It is so assumed that the system A corresponds to a system which uses GSM, whereas the system B corresponds to a system which uses UMTS. A final voltage of the GSM and a final voltage of the UMTS have been previously stored in the storage unit 17. It is also assumed that a communication is executed by the system A using the GSM at the beginning, and no communication is executed by the system B using the UMTS.

Firstly, in response to an instruction issued from the system-A control unit 13, the system-A transmitting/receiving unit 12 performs a reception of a wireless signal from a base station using a GSM network (hereinafter, referred to as “GSM base station”) and a transmission of a wireless signal to the GSM base station via the antenna 11 at the time of a telephone communication (step S301). Since a communication operation is performed, the wireless signal contains voice data.

During the telephone communication using the GSM, the battery voltage detecting unit 19 detects battery voltage information of the battery 21 in a predetermined time period, and sends the battery voltage information to the power supply control unit 16 (step S302). Upon receipt of the battery voltage information, the power supply control unit 16 acquires the final voltage information of the GSM stored in the storage unit 17, and compares the final voltage of the GSM with a present power supply voltage (step 303).

When the result of the comparison in step S303 represents that the present power supply voltage is higher than the final voltage of the GSM, the power supply control unit 16 notifies the system-A control unit 13 to subsequently continue the communication operation using the GSM in the system A, and the system-A transmitting/receiving unit 12 continues the communication operation using the GSM in response to an instruction issued from the system-A control unit 13 (step S304).

On the other hand, when the result of the comparison in step S303 represents that the present power supply voltage is lower than, or equal to the final voltage of the GSM, the power supply-control unit 16 notifies the system-A control unit 13 to stop the communication operation using the GSM in the system A and notifies the system-B control unit 15 to start a communication operation using the UMTS in the system B.

In response to an instruction issued from the system-A control unit 13, the system-A transmitting/receiving unit 12 stops the reception of the wireless signal from the GSM base station and the transmission of the wireless signal to the GSM base station via the antenna 11 at the time of a telephone communication (step S305). Then, in response to an instruction issued from the system-B control unit 15, the system-B transmitting/receiving unit 14 commences a reception of a wireless signal from a base station which performs a communication operation using a UMTS network (hereinafter will be referred to as “UMTS base station”) and a transmission of a wireless signal to the UMTS base station via the antenna 11 at the time of the telephone communication (step S306), and thereafter the process operation is accomplished.

When the system which is used in this telephone communication (GSM in FIG. 3) is reached to the final voltage, if another system (UMTS in FIG. 3) is not reached to the final voltage and is communicable, then the present system can be handed over to the latter system.

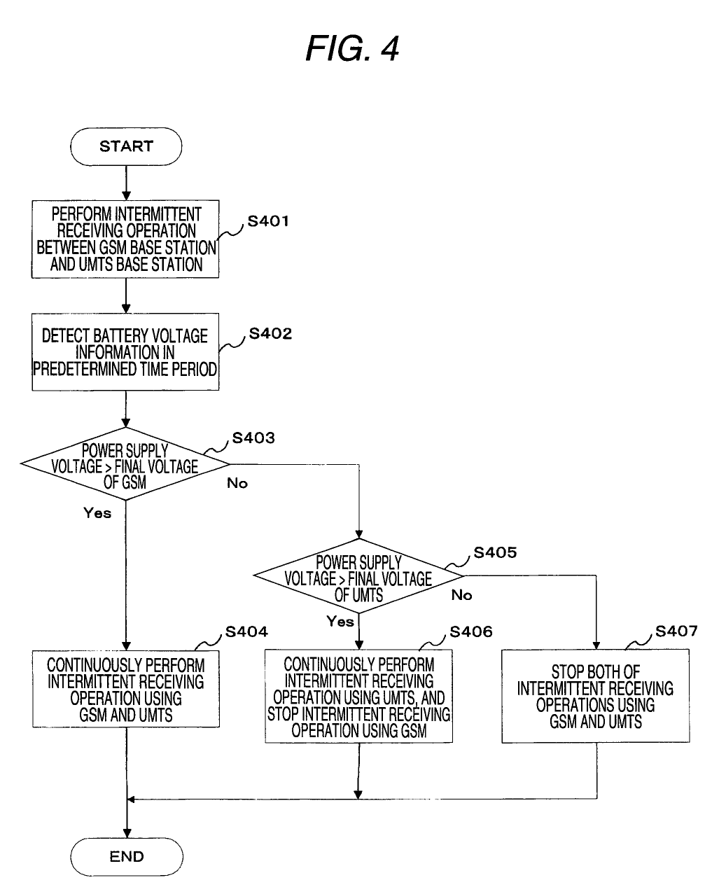

A description will now be made of such a case that the wireless communication apparatus 100 of the embodiment is operated in a telephone call waiting mode. FIG. 4 is a flow chart for explaining operations when the wireless communication apparatus 100 of the embodiment of the invention is operated in the telephone call waiting mode. It is so assumed that the system A corresponds to a system which uses GSM, whereas the system B corresponds to a system which uses UMTS. A final voltage of the GSM and a final voltage of the UMTS have been previously stored in the storage unit 17. It is also assumed that the system A and the system B are both performing intermittent receiving operations by which radio waves transmitted from the GSM base station and the UMTS base station are received in a constant time interval.

When the wireless communication apparatus 100 is operated in the telephone call waiting mode, both of the system A and the system B are performing the above-described intermittent receiving operations. In other words, the system-A transmitting/receiving unit 12 is performing a communication operation of a wireless signal with the GSM base station via the antenna 11 in the intermittent receiving operation in response to an instruction issued from the system-A control unit 13, and the system-B transmitting/receiving unit 14 is performing a communication operation of a wireless signal with the UMTS base station via the antenna 11 in the intermittent receiving operation in response to an instruction issued from the system-B control unit 15 (step S401) Since the intermittent receiving operations are carried out, the wireless signal contains a control signal for performing the intermittent receiving operation.

During an intermittent receiving operation using the GSM and the UMTS, the battery voltage detecting unit 19 detects battery voltage information of the battery 21 in a predetermined time period, and sends out the detected battery voltage information to the power supply control unit 16 (step S402). Upon receipt of the battery voltage information, the power supply control unit 16 acquires the final voltage information of the GSM and the UMTS stored in the storage unit 17, and first of all, compares the final voltage of the GSM higher than that of the UMTS with a present power supply voltage (step 403).

When the result of the comparison in the step S403 indicates that the present power supply voltage is higher than the final voltage of the GSM, the power supply control unit 16 notifies the system-A control unit 13 to subsequently continue the intermittent receiving operation using the GSM, and notifies the system-B control unit 15 to subsequently continue the intermittent receiving operation using the UMTS (step S404).

On the other hand, when the result of the comparison in the step S403 shows that the present power supply voltage is lower than, or equal to the final voltage of the GSM, the final voltage of the UMTS is subsequently compared with the current power supply voltage (step S405).

When the result of the comparison in the step S405 represents that the present power supply voltage is higher than the final voltage of the UMTS, the power supply control unit 16 notifies the system-B control unit 15 to subsequently continue the intermittent receiving operation using the UMTS, and notifies the system-A control unit 13 to stop the intermittent receiving operation using the GSM. In response to an instruction issued from the system-A control unit 13, the system-A transmitting/receiving unit 12 accomplishes the communication operation by the wireless signal with the GSM base station via the antenna 11 and stops the intermittent receiving operation (step S406).

When the result of the comparison in the step S405 represents that the present power supply voltage is lower than, or equal to the final voltage of the UMTS, the power supply control unit 16 notifies the system-A control unit 13 to stop the intermittent receiving operation using the GSM, and notifies the system-B control unit 15 to stop the intermittent receiving operation using the UMTS. In response to an instruction issued from the system-A control unit 13, the system-A transmitting/receiving unit 12 stops the communication operation by the wireless signal with the GSM base station via the antenna 11 so as to stop the intermittent receiving operation, and in response to an instruction issued from the system-B control unit 15, the system-B transmitting/receiving unit 14 stops the communication operation by the wireless signal with the UMTS base station so as to stop the intermittent receiving operation (step S407), and thereafter the process operation is ended.

As previously explained, since the supply of the electric power to the system whose voltage becomes the final voltage (GSM in FIG. 4) is cut off so as to stop the intermittent receiving operation, it is possible to reduce wasteful power consumption and increase the telephone call waiting time.

In accordance with the wireless communication apparatus 100 in the embodiment of the present invention, the wireless communication apparatus 100 capable of being communicated by employing a plurality of communication systems is arranged by employing: a plurality of communication units containing a system-A transmitting/receiving unit 12 and system-A control unit 13 for performing a communication operation by a wireless signal using a GSM communication system, and a system-B transmitting/receiving unit 14 and a system-B control unit 15 for performing a communication operation by a wireless signal using a UMTS communication system; a storage unit 17 for storing thereinto final voltages of the communication systems with respect to the plural communication systems; a power supply voltage detecting unit 19 for detecting a voltage of a power supply applied to the plural communication units in a predetermined time period; a power supply control unit 16 operated in such a control manner that while a power supply voltage is compared with the final voltage for each of the plural communication systems, as a result of the comparison, when the power supply voltage is lower than, or equal to the final voltage of the GSM communication system, the communication operation by the system-A transmitting/receiving unit 12 and the system-A control unit 13 is stopped, whereas the power supply voltage is higher than the final voltage of the UMTS communication system as a result of the comparison, the communication operation by the system-B transmitting/receiving unit 14 and the system-B control unit 15 is continuously carried out. The above-explained arrangement can permit wasteless use of the battery energy by setting the adequate final voltage system by system. Also, since the supply of the electric power to the system whose voltage becomes the final voltage is cut off so as to stop the intermittent receiving operation, it is possible to reduce wasteful power consumption and increase the telephone call waiting time. Further, when the voltage becomes the final voltage during the telephone communication, in the case that another system is not reached to the final voltage but is communicable, the present system is handed over to this system, so that the telephone communication can be continuously carried out.

Although the explanation has been made of such an example that the wireless communication apparatus 100 owns two systems in the present invention, this inventive idea may be similarly applied to such a wireless communication apparatus having three or more systems. Although two systems are the GSM and the UMTS as one example, other systems may be used as well.

### INDUSTRIAL APPLICABILITY

The present invention is useful in a wireless communication apparatus or the like that has a plurality of systems and can allow a system having the lowest requirement for the battery voltage to use up the battery energy.

1. A wireless communication apparatus capable of being communicated by employing a plurality of communication systems, comprising:
a plurality of communication units including a first communication unit for performing a communication operation by a wireless signal using a first communication system and a second communication unit for performing a communication operation by a wireless signal using a second communication system;
a storage unit for storing thereinto final voltages of the communication systems with respect to the plurality of communication systems;
a power supply voltage detecting unit for detecting a voltage of a power supply applied to the plurality of communication units in a predetermined time period;
a comparing unit for comparing the power supply voltage with the final voltage for every communication systems; and
a power supply control unit operated in such a control manner that as a result of the comparison made by the comparing unit, when the power supply voltage is lower than, or equal to the final voltage of the first communication system, the communication operation by the first communication unit is stopped, whereas when the power supply voltage is higher than the final voltage of the second communication system, the communication operation by the second communication unit is continuously carried out.

2. The wireless communication apparatus according to claim 1, wherein
in the case that the power supply voltage is lower than, or equal to the final voltage of the first communication system, and the power supply voltage is higher than the final voltage of the second communication system as a result of the comparison made by the comparing unit, the power supply control unit switches the communication operation from the first communication unit to the second communication unit.

3. A wireless communication method capable of being communicated by employing a plurality of communication systems, comprising:
a first communication step of performing a communication operation by a wireless signal using a first communication system;
a second communication step of performing a communication operation by a wireless signal using a second communication system;
a step of storing thereinto final voltages of the communication systems with respect to the plural communication systems;
a step of detecting a voltage of a power supply applied to the plural communication units in a predetermined time period;
a comparing step of comparing the power supply voltage with the final voltage for every communication system; and
a step of stopping the communication operation by the first communication step when the power supply voltage is lower than, or equal to the first voltage of the first communication system as a result of the comparison made by the comparing step, and continuously Carrying out the communication operation by the second communication step when the power supply voltage is higher than the final voltage of the second communication system as the result of the comparison made by the comparing step.

4. A wireless communication method according to claim 3 wherein:
in the case that the power supply voltage is lower than, or equal to the final voltage of the first communication system, and further, the power supply voltage is higher than the final voltage of the second communication system as a result of the comparison made by the comparing step, the power supply control step switches the communication operation from the first communication step to the second communication step.
